(19) United States
(12) Patent Application Publication
(10) Pub. No.: US 2019/0066000 A1
(43) Pub. Date: Feb. 28, 2019

(54) Systems and methods for creating a personalized digital or physical item

(71) Applicant: Selfie Stub LLC, New York, NY (US)

(72) Inventors: Jovany Veloz, Tampa, FL (US); John Travis Charleville, Festus, MO (US); Nicholas Schimpf, St. Louis, MO (US); John Osborn, II, Wentzville, MO (US)

(73) Assignee: Selfie Stub LLC, New York, NY (US)

(21) Appl. No.: 16/118,396

(22) Filed: Aug. 30, 2018

Related U.S. Application Data
(60) Provisional application No. 62/552,899, filed on Aug. 31, 2017.

(51) Int. Cl. G06Q 10/02; G06F 3/0484; G06F 17/30; G06Q 20/32; G06Q 30/06

(52) U.S. Cl. CPC G06Q 10/02; G06F 3/04845; G06Q 30/0601; G06Q 20/3224; G06F 17/30887

(57) ABSTRACT

One or more methods, systems, apparatuses, applications, or some combination thereof, comprise an exemplary Selfie Stub system. According to aspects of the present invention, an exemplary system may utilize an application executing on a user's mobile device, e.g., phone, tablet, portable computer, etc., in operative communication with one or more back-end systems, e.g., servers, data stores, various computing devices, etc., to enable the user to develop and customize a commemorative physical and/or digital item, e.g., a commemorative ticket stub, and give them the opportunity to purchase/receive a digital stub, a physical stub, or both.

### CROSS-REFERENCE TO RELATED APPLICATION

This application claims the benefit of U.S. Provisional Application 62/552,899, filed Aug. 31, 2017.

### TECHNICAL FIELD

The present disclosure relates generally to one or more methods, systems, and/or apparatuses for interactively capturing consumer moments via one or more customized physical or digital items, or some combination thereof.

### BACKGROUND ART

Aspects of the present invention allow a consumer to capture a moment with their date, friends, or family at any venue, and personalize the captured moment with information such as seating information, captioned message, and the like. Previous attempts at personalized ticket frames/invitations/mascot ticket album, etc., such as “That's My Ticket” (presently at http://www.thatsmyticket.com), required a consumer to add a photo that had to be incorporated with either a custom ticket or theme ticket frames to help create memories from special events. The general idea of these types of systems are to create a way to utilize the customer's photo to enhance the memory of the event; however, these systems generally require a customer to take a photo, ship/send the photo to the 3rd party, then wait and hope the product met their expectations. Other services, such as All Net Photo (http://allnetphoto.com), take pictures of attendees at an event, where the attendees are given a piece of paper that indicates a website and specific page to navigate to and visually search for their picture. Once an attendee manually locates their picture(s), the attendee may then purchase the photos. As a result, existing systems have significant limitations/disadvantages—for example, their process can take multiple days to produce, even before adding in the time for delivery, or their process may require a user to manually search for their one photo among hundreds of photos. Additionally, their manual processes are not easy for consumers to use and do not provide consumers with the ability to customize the item for the specific event/date/seating information/location/selfie, etc.

### SUMMARY DISCLOSURE OF INVENTION

The following presents a simplified summary in order to provide a basic understanding of some aspects of the invention. This summary is not an extensive overview. It is not intended to identify key or critical elements of the invention or to delineate the scope of the invention. The following summary merely presents some concepts of the invention in a simplified form as a prelude to the more detailed description provided below.

Aspects of the present invention advantageously allows consumers to capture moments in a unique way by putting your selfie on a physical or digital ticket stub, or other appropriate physical item(s). Aspects of the present invention relate to one or more methods, systems, apparatuses, applications, or some combination thereof, that comprise an exemplary “Selfie Stub” system. According to aspects of the present invention, an exemplary system may utilize an application executing on a user's mobile device, e.g., phone, tablet, portable computer, etc., in operative communication with one or more back-end systems, e.g., servers, data stores, various computing devices, etc., to enable the user to develop and customize their selfie stub and give them the opportunity to purchase/receive a digital stub, a physical stub, or both.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which the drawings show several exemplary embodiments:

FIGS. 1A-1E illustrate exemplary flow diagrams of one or more exemplary steps a user may take when utilizing an exemplary mobile application, according to various aspects described herein.

FIGS. 2A-2O illustrate exemplary application screenshots of an exemplary mobile application, according to various aspects described herein.

FIG. 3 illustrates one or more exemplary administrative tools (whether by dedicated applications or via a web interface) which an enable administrator user to, among other things, add/modify/delete or otherwise administer one or more aspects of the present invention, according to various aspects described herein.

FIG. 4 is a block diagram illustrating an example of a suitable computing system environment in which aspects of the present invention may be implemented.

### DETAILED DESCRIPTION OF THE INVENTION

In the following description of the various embodiments, reference is made to the accompanying drawings, which form a part hereof, and in which is shown by way of illustration various embodiments in which features may be practiced. It is to be understood that other embodiments may be utilized, and structural or functional modifications may be made.

According to aspects of the present invention, one or more methods, systems, apparatuses, applications, or some combination thereof, comprise an exemplary Selfie Stub system. An exemplary Selfie Stub system may utilize an application executing on a user's mobile device, e.g., phone, tablet, portable computer, etc., in operative communication with one or more back-end systems, e.g., servers, data stores, various computing devices, etc., to enable the user to develop and customize their selfie stub and give them the opportunity to purchase/receive a digital stub, a physical stub, or both. One or more aspects of an exemplary application are described herein. One or more aspects of an exemplary back-end system are described herein as well.

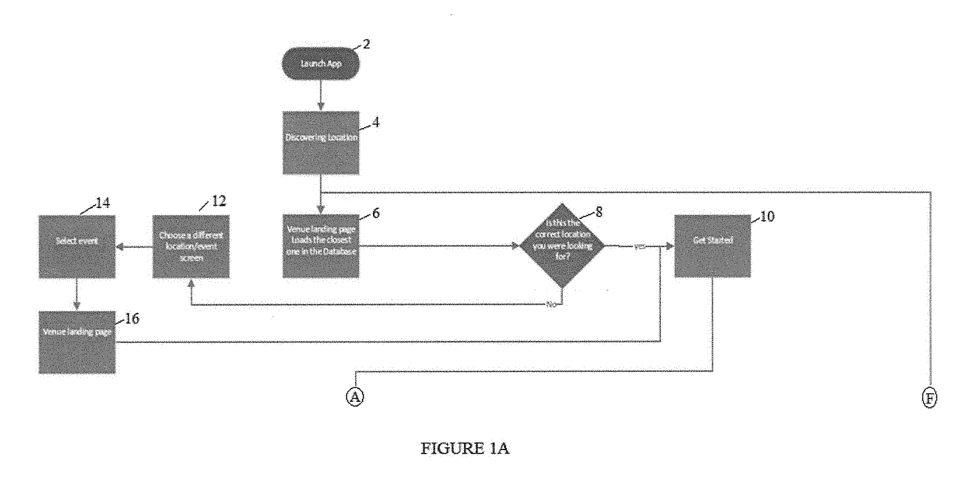

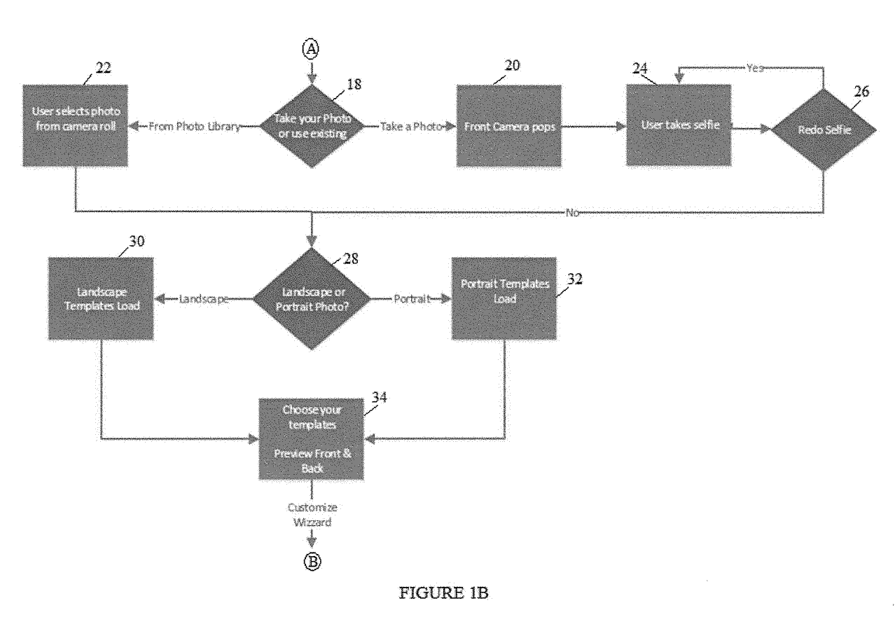

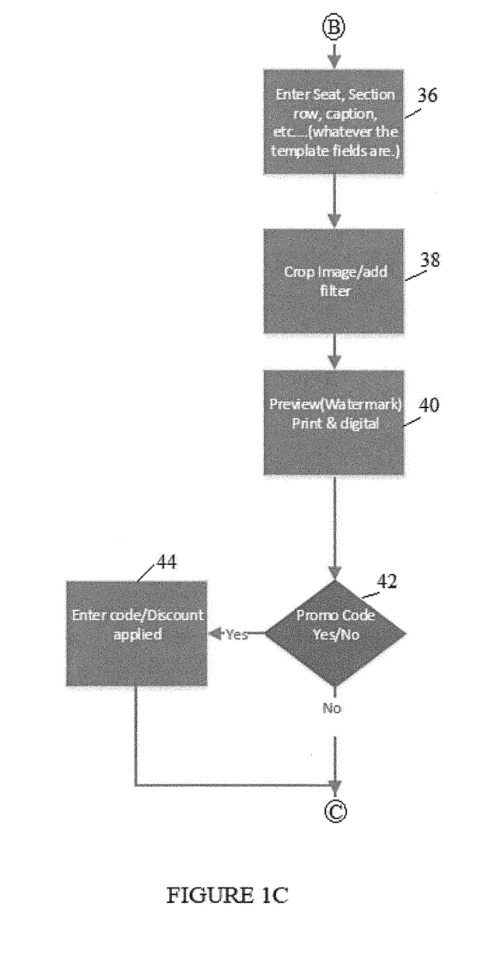

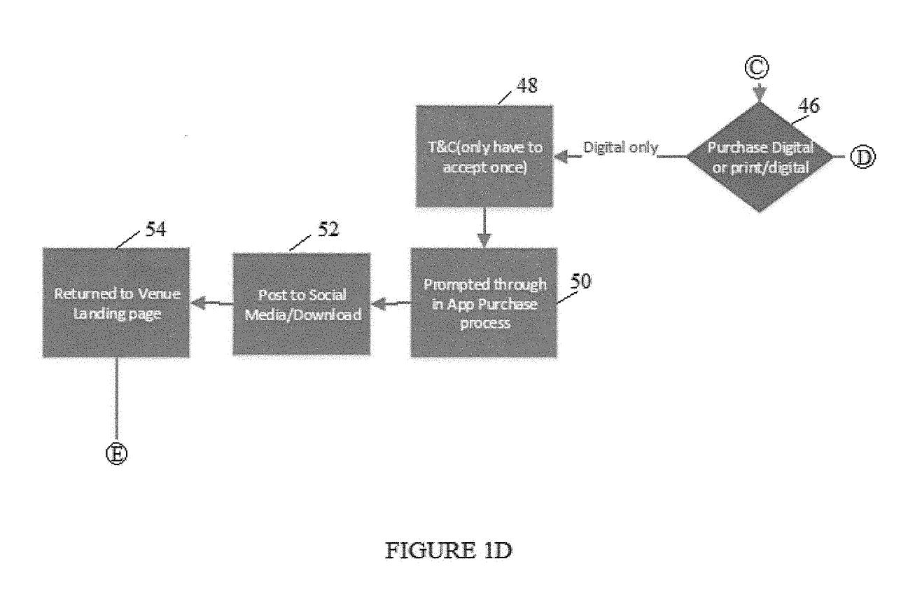

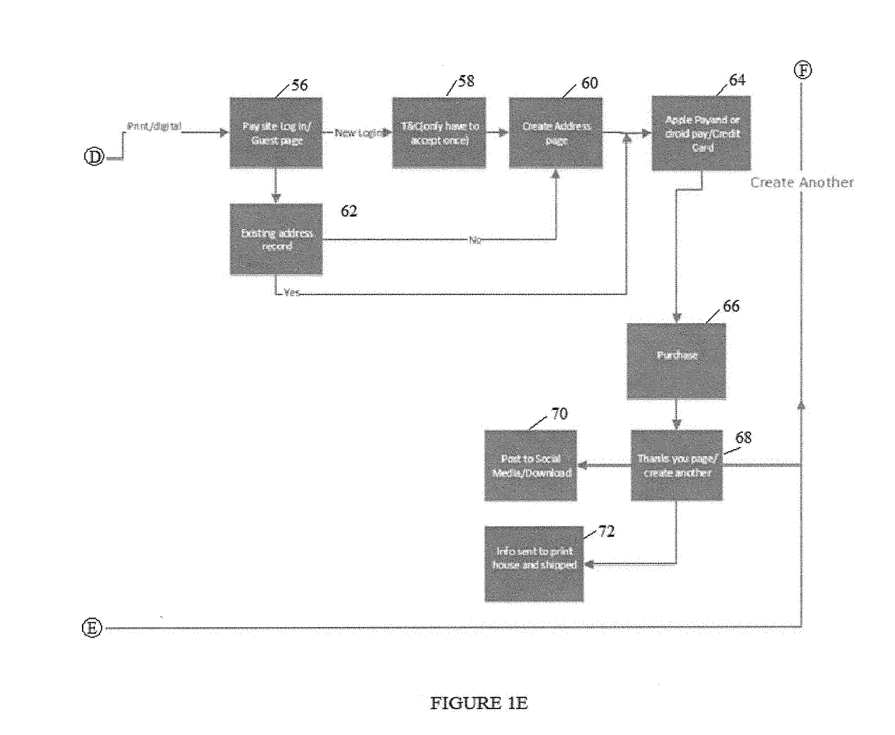

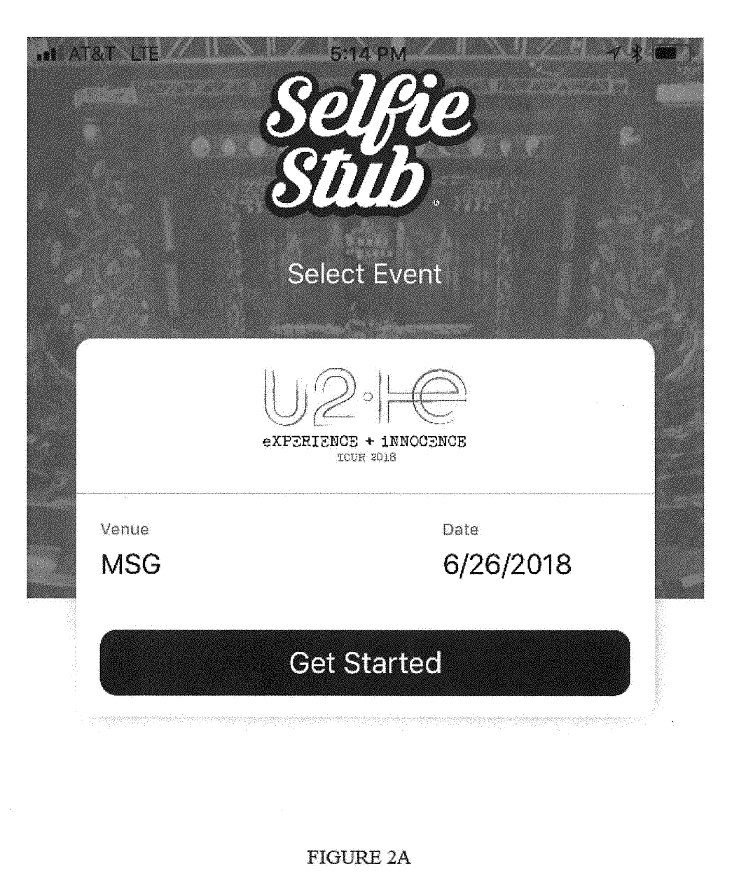

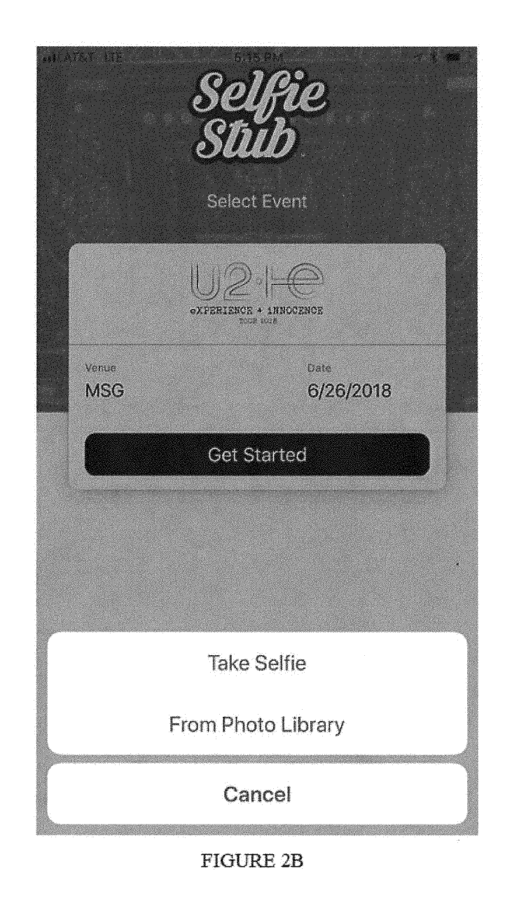

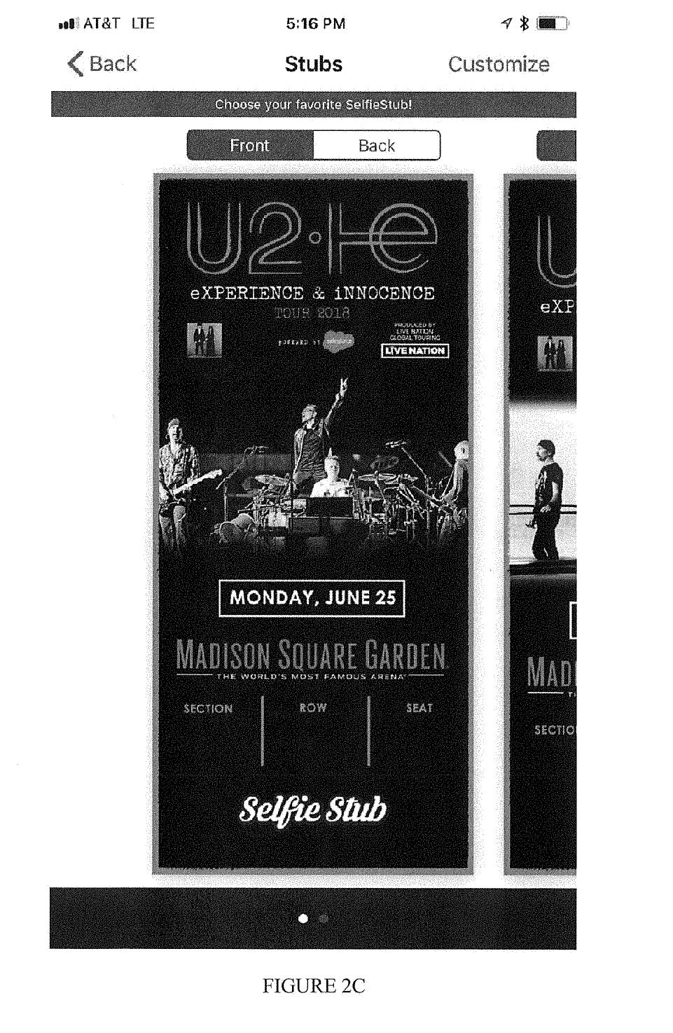

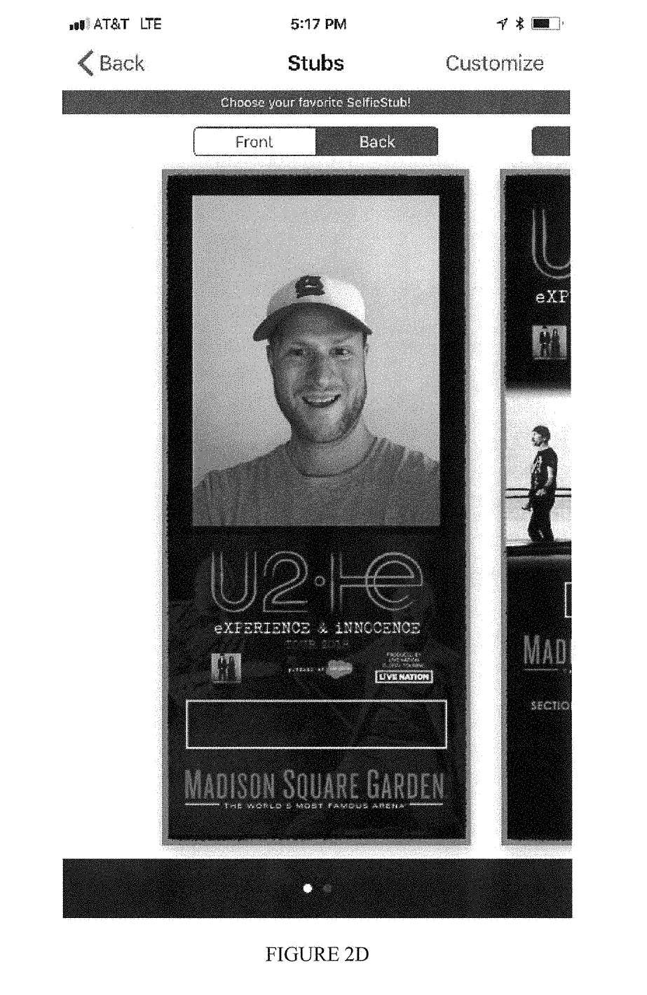

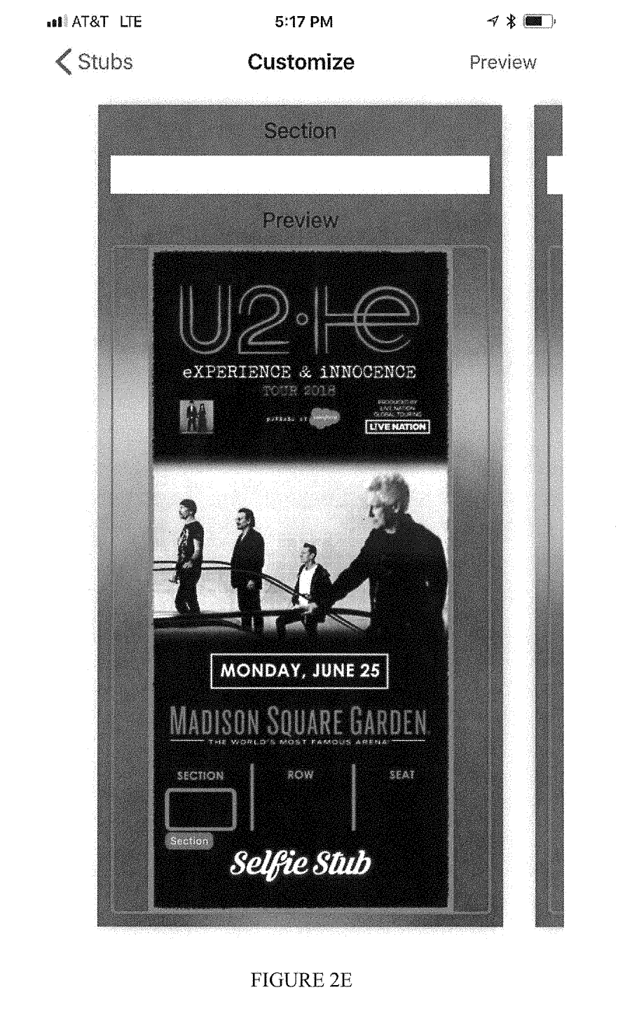

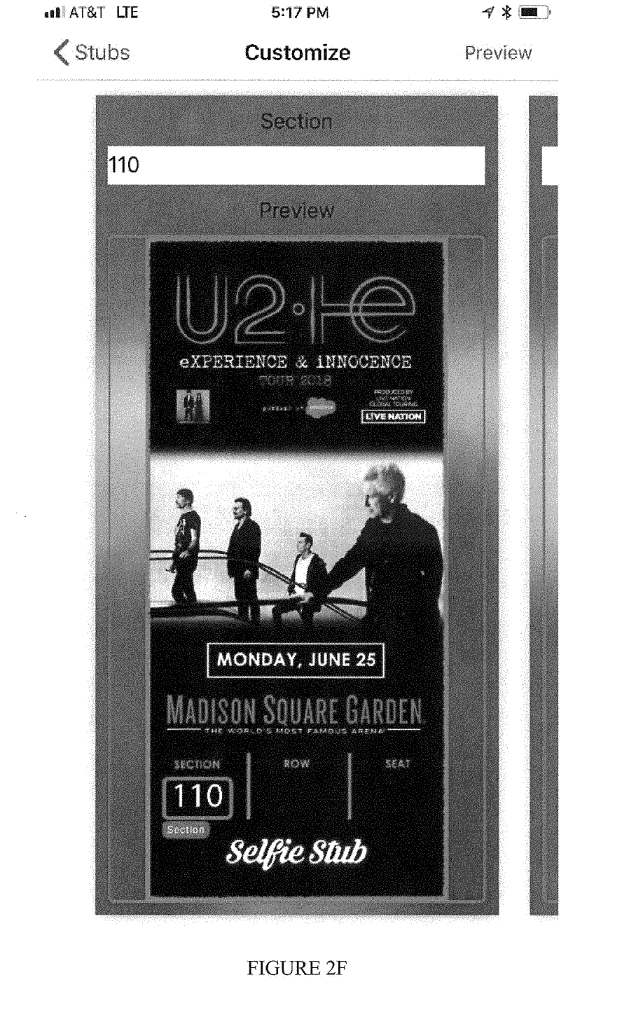

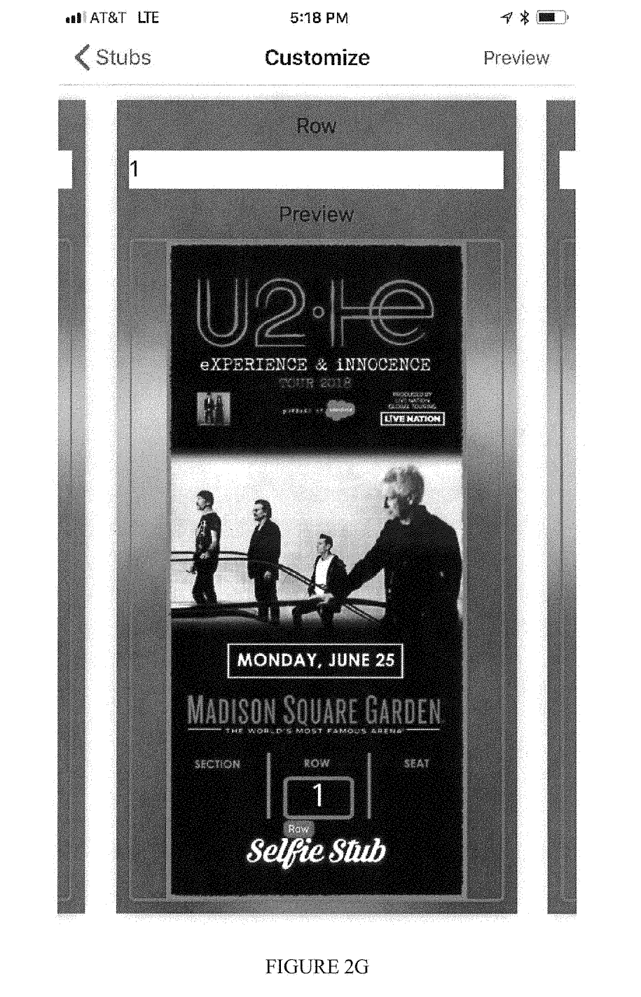

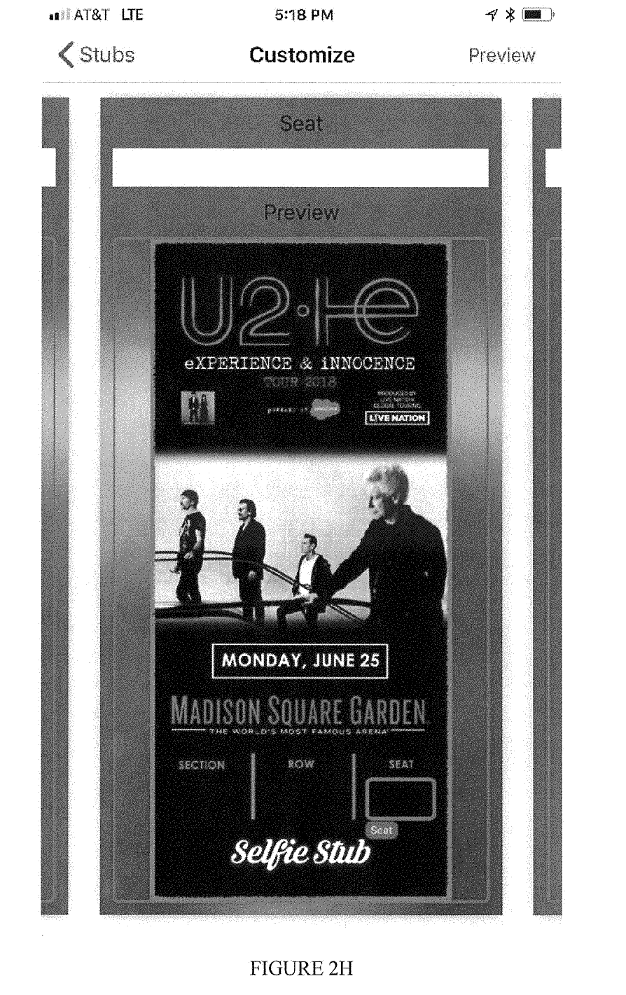

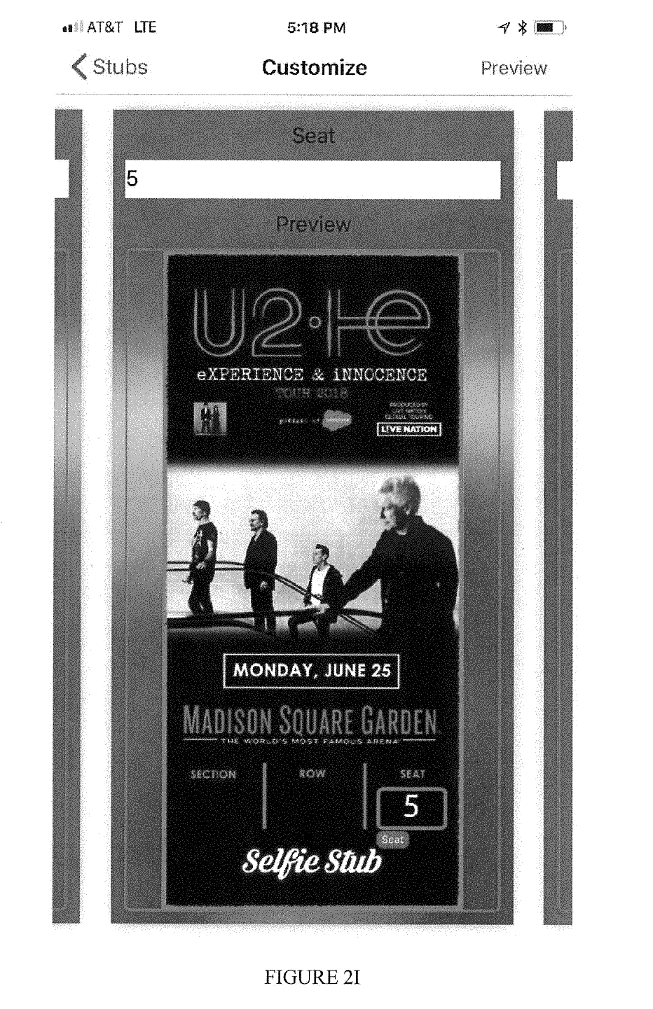

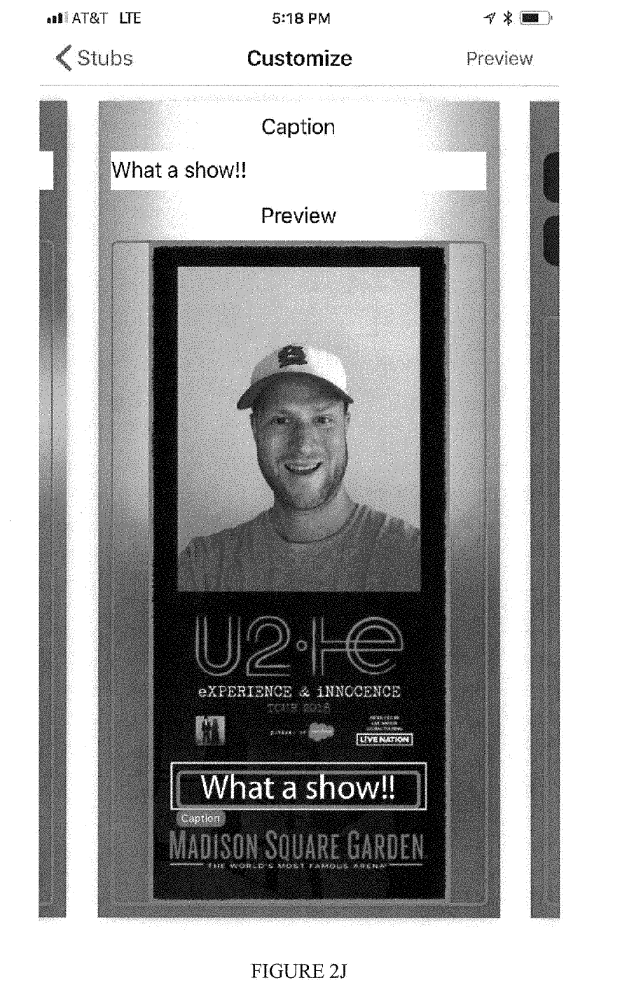

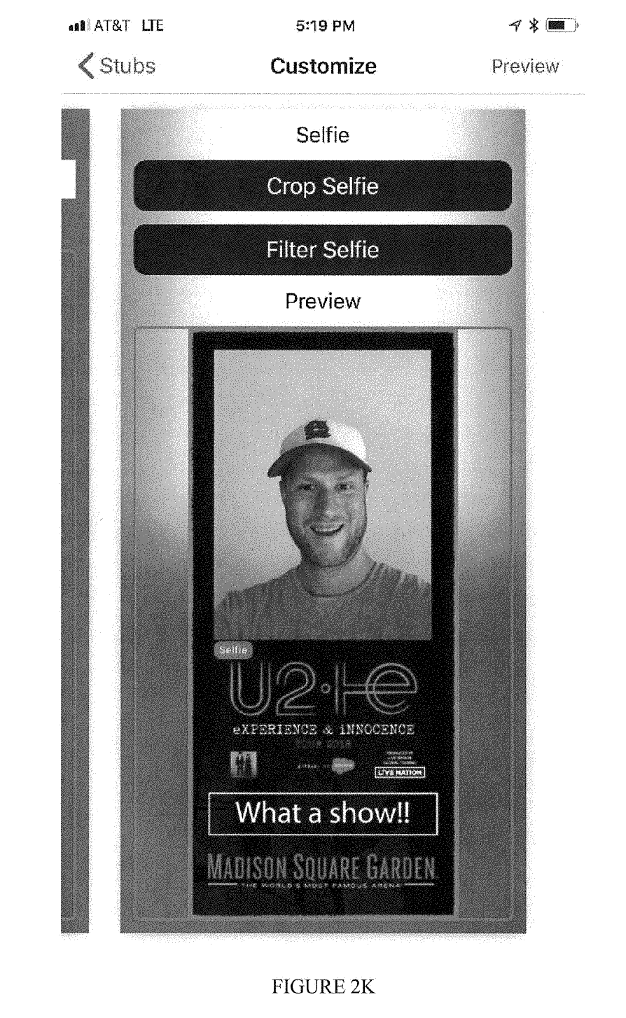

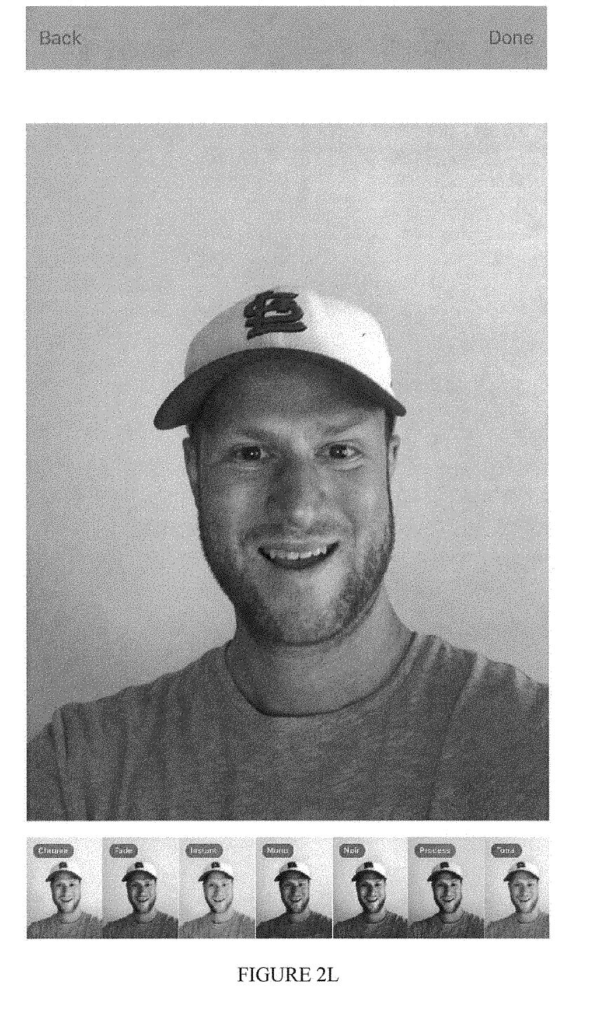

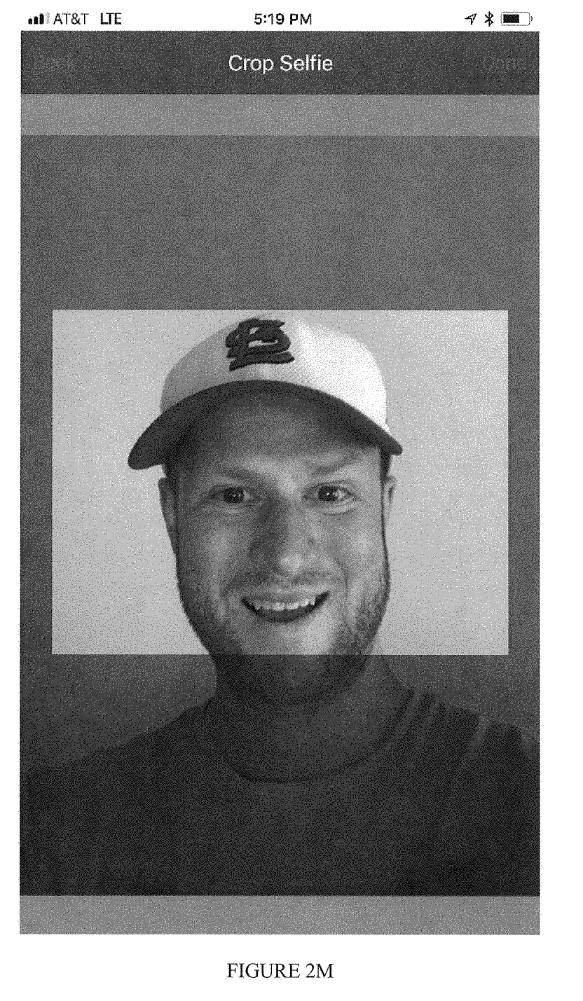

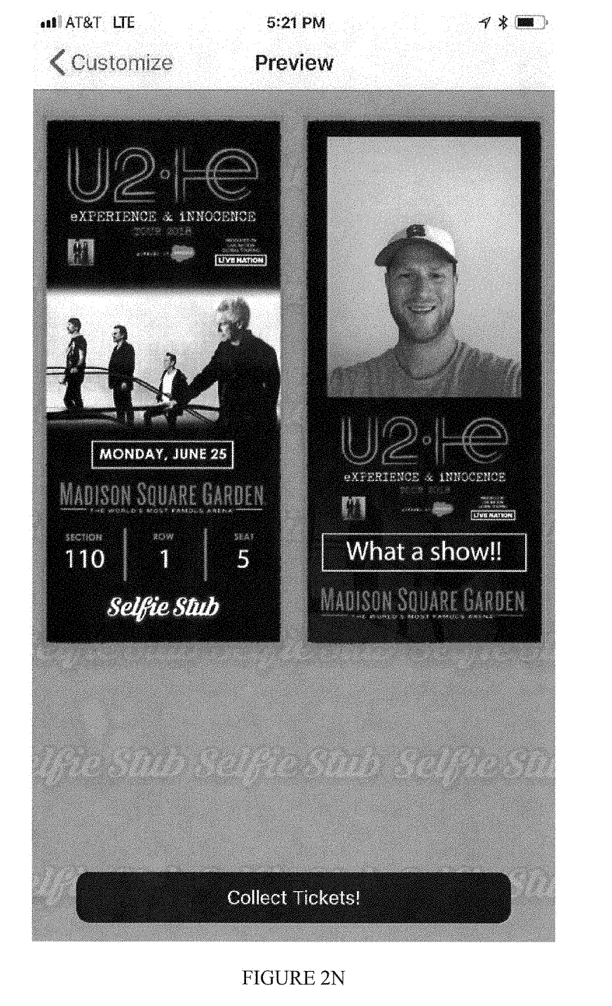

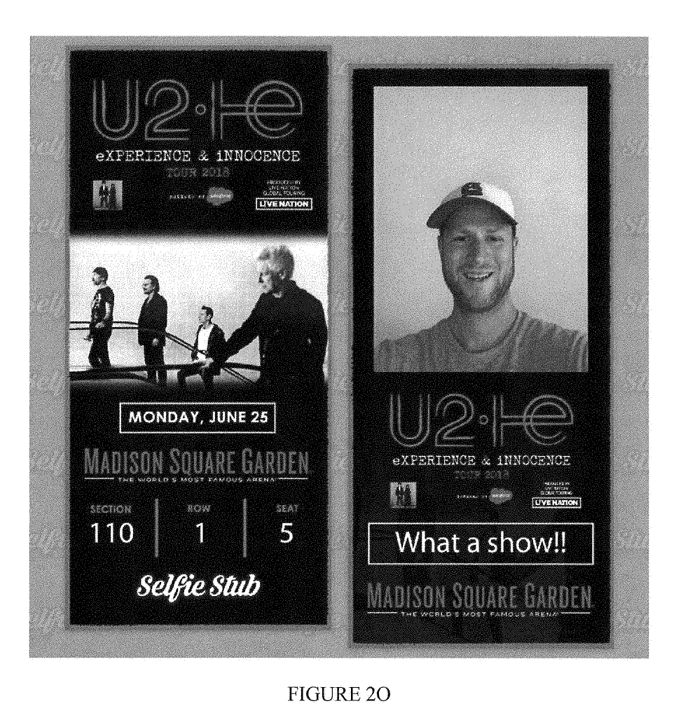

FIGS. 1A-1E illustrate, among other things, an exemplary flow diagram demonstrating one or more steps a user may take when utilizing an exemplary mobile application; exemplary application screenshots are illustrated in FIG. 2A-2O (“LiveNation” and “U2” are the trademarks of their respective owners). For example, in FIG. 1A, a user may launch the application at 2, where the application may then attempt to determine the location of the user via the user's device at 4, such as by way of GPS, wireless access point locations, etc. Based on the application's determination of the user device's location, the application may communicate with one or more elements of an exemplary back-end system to retrieve or otherwise receive data regarding venues, venue locations, and events associated with those venues. The exemplary application may then determine one or more venue locations that correspond to the user's device present location at 6.

A venue location is determined at 6 and the application presents a venue landing page to the user at 8 (e.g., FIG. 2A) for a venue that is determined to be the closest venue to the user device's location. The application may then prompt the user at 8, via one or more user interfaces (UIs”) on a display of the user's device, to confirm that the venue location displayed to the user is correct (e.g., FIG. 2A)—if yes, the application may proceed to start the user's selfie stub at 10; if no, the application may proceed to one or more UIs for the user to select a different location at 12, select an appropriate event at different event at 14, at which point the application may display an appropriate landing page at 16. For example, one or more “UIs may prompt the user to select “More Events” via a button, link, or other appropriate UI elements, enabling the user to select the appropriate event/venue location(s) to determine if this is the event they are attending that day. In some embodiments, the application may display a list of dates and/or different venues to the user, from which the user may select which date and venue for which they want to create a customized selfie stub. If the customer is not in the correct location for the desired event(s), one or more UIs may enable the user to search, e.g., either via city or zip code, to find events for the current day and/or past dates of events. The user may then select an appropriate event at 14, after which the user may start their selfie stub at 10.

Turning now to FIG. 1B, the exemplary application enables the user to begin customizing their selfie stub. For example, the application may prompt the user at 18, via one or more UIs, to provide a photo for inclusion on the stub (e.g., FIG. 2B). For example, the application may enable the user to take a photo at that time (assuming the user's device has such capabilities) at 20 (either using a front-facing camera, a rear-facing camera, or other photo acquisition device in operative communication with the user's device) or use an existing photo that is accessible by the user's device and the application at 22. If the user chooses to take a photo, the user takes a photo at 24. The application may then prompt the user to confirm the photo selection at 26—if the user declines, the process returns to 24 so that the user may re-select the desired photo. At 28, the application determines an orientation of the desired photo, e.g., landscape or portrait. In some embodiments, the application may prompt the user to indicate an orientation for the photo, e.g., landscape, portrait, or other appropriate selection. For example, if the user selects “landscape” orientation, the application may load one or more “selfie” template shells at 30; if the user selects “portrait” orientation, the application may load one or more “selfie” template shells at 32. According to aspects of the present invention, one or more template shells may be stored local to the application; however, the application may additionally communicate with one or more elements of an exemplary back-end system to retrieve or otherwise receive shells, data regarding the shells, or some combination thereof. Once loaded, the application may display one or more of the loaded templates to the user for selection, for example by displaying a front preview, back preview, or both.

According to aspects of the present invention, the UIs may display locally-stored (e.g., in memory, hard drive, SSD, etc.) shells, shells retrieved from one or more servers that are remote relative to the user's device, or some combination thereof, for user selection. The UIs may show the front view of an exemplary stub based on a template shell, a back view of an exemplary stub based on a template shell, or both (e.g., FIG. 2C-2D). Importantly, these template shells are configured with predefined fields that overlay the stub, such that user-supplied information and photos may be added in the appropriate locations on the stub, like described below.

Once the user selects the desired template, the process continues to 36 (see FIG. 1C). The exemplary application may then prompt the user to enter information relevant to the event, such as but not limited to, gate, section, row, seat, other pertinent information, or some combination thereof (e.g., FIG. 2E-2F, “Section” customization; 2G, “Row” customization; 2H-2I, “Seat” customization; 2J, “Caption” customization). In some embodiments, one or more of these or other fields may be pre-populated with information, e.g., information specified by a partnered business, organization, venue, etc. Next, the application may provide the user with the opportunity to crop, resize, re-position, or otherwise modify the photo at 38, e.g., add/apply/remove one or more filters (e.g., FIG. 2K, “Preview” view; 2L, “Filter” selection; 2M, “Crop” view). The user may then preview their stub in its final state at 40 (e.g., FIG. 2N)—e.g., their template selection, customizations, photo, etc.—to ensure the customizations and photo are correct and the final stub is accurate, before proceeding to purchase (e.g., FIG. 2O illustrating a finalized version of the user's customized item). If the user desires to make changes, the application may return them to the appropriate step in the process to make the desired changes.

Next, the application may prompt the user to enter a promo code at 42. If the user enters a promo code, the application applies the promo code as appropriate at 44, for example, the application may decline to apply a promo code if it is expired, unknown, unauthorized, or otherwise not available in the application. If a promo code is not entered or the application has applied one or more promo codes as appropriate, the application proceeds to 46. (A similar process may be included prior to or during purchase, such as between elements 64 and 66 in FIG. 1E). The exemplary application may then prompt the user to select whether they want to purchase a digital-only stub or a print/digital version at 46—if digital only, the user is prompted to accept the application's terms and conditions/terms of service 48 (if this is the first time the user has utilized the application) and, once the terms are accepted, the application prompts the user to complete an in-app purchase process at 50, e.g., through an in-app purchase via the Apple App Store on an iOS device or Google Play Store on an Android device. Upon successful completion of the appropriate payment processes, the user's purchase is completed at 50, after which the application provides the user with the appropriate UI, such as but not limited to, a confirmation/“Thank You” page (not illustrated), an option return to the venue landing page and create another stub at 54 (via elements E and F back to 6), an option to post a copy of the digital stub to social media 52, and/or download the digital version of their stub (e.g., FIG. 2O).

If the user selects the print/digital option, the process continues at 56, where the user is prompted to either log into their account or proceed as “guest”. One of ordinary skill in the pertinent arts will understand that while elements 56, 58, and 60 comprise a login/guest/new account creation process, other processes/steps may be utilized without departing from the scope of the present invention. If the user selects to ship/deliver to a new address at 62, the application prompts the user to create a new address at 60. Once the user enters a new address or selects an existing address, the application prompts the user at 64 to pay via an appropriate payment process, e.g., Apple Pay, Droid Pay, credit/debit card, Paypal, etc. Optionally, the application may prompt the user to enter a promo code between 64 and 66 (not shown). Upon successful completion of the appropriate payment processes, the user's purchase is completed at 66, after which the application provides the user with the appropriate UI, such as but not limited to, a “Thank You” page 68, an option to create another stub (via element F to 6), an option to post a copy of the digital stub to social media and/or download the digital version of their stub 70. The appropriate information for the user's order may then be transmitted or otherwise delivered to a print house (or other appropriate entity, system, subsystem, or the like) for printing and shipping the user's stub 72.

During execution of the application, application may be in operative communication with one or more app stores to facilitate in-app purchases (not illustrated). An exemplary application may additionally be in operative communication with one or more elements, systems, methods, apparatuses, devices, etc., that may be collective categorized as a back-end system (not illustrated), analytics system, or other suitable systems, devices, or methods. One of ordinary skill in the art will understand that, while the back-end system is referred to as a singular “unit”, the elements, systems, methods, apparatuses, devices, etc. comprising an exemplary back-end system may be separate and remote from each other without departing from the scope of the present invention. For example, while an exemplary analytics system is described separately, in some embodiments, it may be included in a back-end system.

According to aspects of the present invention, one of ordinary skill in the art will understand that a back-end system stores information such as events, venues, statistics, template shells, user profiles, artists/performers/teams, promo codes, orders, and information/functionality for payment processing. Functionality, data, and the like may be transmitted to/from an exemplary back-end system via one or more API calls, RPC calls, or other appropriate means—for example, an exemplary pay site may transmit into the back-end system and an analytics system, as well as to an external payment processor, such as Stripe, Square, or other appropriate system or service.

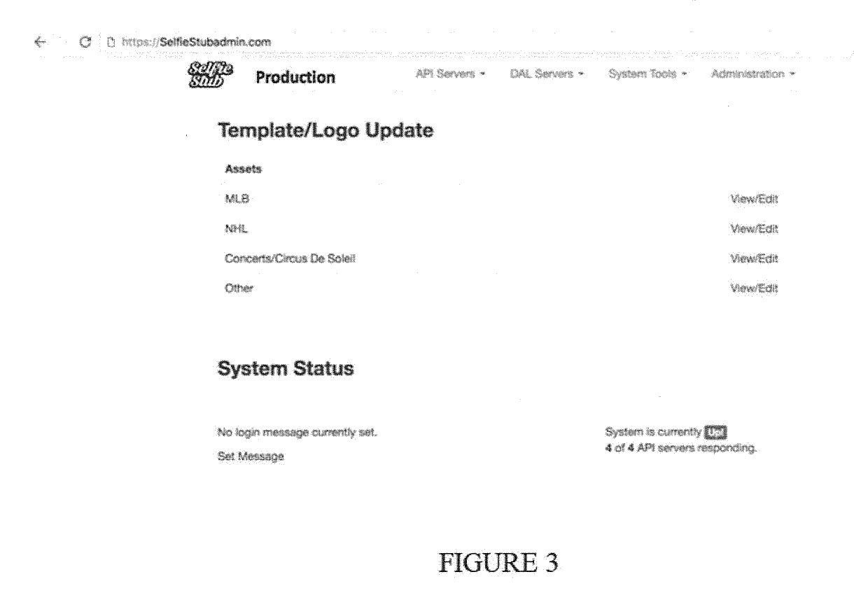

According to aspects of the present invention, one or more administrative tools (whether by dedication applications or via a web interface) enable administrator user to add/modify/delete or otherwise administer one or more aspects of the Selfie Stub system. For example, FIG. 3 illustrates an exemplary user interface where an administrator may view/edit assets such as logos, template shells, etc. one or more aspects of the system. According to aspects of the present invention, generic templates may be provided for use by other venues, such as high school/university graduations, amusement park stubs, and other venues. For example, the user may be prompted at the relevant point(s) in the process to pose with the performer/event/venue, such that a selfie picture may be taken to capture the event, e.g., photo with the performer, photo while sitting in roller coaster car, etc.

Advantageously, aspects of the present invention, such as those described above, reduces the likelihood of user refund requests (absent printer error), as the user enters their own information and photo and previews the final stub before purchasing. In the event of such an error, an exemplary Selfie Stub system make provide one or more UIs, such as a website, to submit a refund request along with a photo of the incorrect stub. Such a request may be automatically approved/denied, manually approved/denied, or some combination thereof, along with additional instructions based on the approval/denial, e.g., returning the printed stub.

Advantageously, aspects of the present invention, such as those described above, enable a user to select their ticket stub design, customize their ticket stub design, place a selfie (or other photo) on a physical ticket stub and/or a digital ticket stub, and quickly and easily make payment from an enjoyable and easy-to-use interface. In the case of a digital stub, aspects of the present invention enable the user to share their digital stub instantly via social media, e.g., Facebook, Twitter, Instagram, etc. If the user elects to save their social media account information in their Selfie Stub system profile, sharing via social media may happen even quicker. In some embodiments, aspects of the present invention enable the customization of other physical items, such as water bottles, mugs, mouse pads, calendars, or any other appropriate items or articles that are amenable to customization. As such, the process described above may proceed in a manner appropriate to the item—for example, in the case of a water bottle/mug, the application may or may not prompt for section/row/seat information, and the previews shown in the FIGURES would not be applicable to these items.

Additionally, while the process described above and the FIGURES indicate one or more payment processes, in some embodiments, the application may not require payment information—e.g., advertising-supported operation and/or purchases. In those embodiments, the application may proceed in the manner generally described above, while omitting or altering those steps involving or related to the acquisition of the user's payment information.

In summary, aspects of the present invention advantageously provide the user with a fast and easy process with full customization, unlike the previous, existing methods which permitted little-to-no customization and took many days/weeks to complete. One of ordinary skill in the pertinent arts will recognize that, while various aspects of the present invention are illustrated in the FIGURES as separate elements, one or more of the elements may be combined, merged, omitted, or otherwise modified without departing from the scope of the present invention.

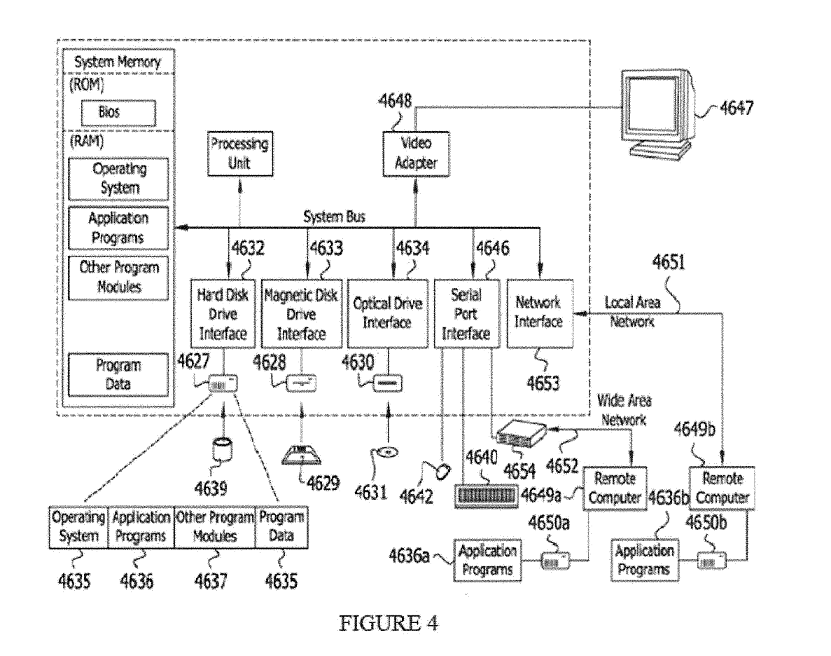

With reference to FIG. 4, an exemplary system for implementing aspects of the invention includes a general-purpose computing device in the form of a conventional computer 4320, including a processing unit 4321, a system memory 4322, and a system bus 4323 that couples various system components including the system memory 4322 to the processing unit 4321. The system bus 4323 may be any of several types of bus structures including a memory bus or memory controller, a peripheral bus, and a local bus using any of a variety of bus architectures. The system memory includes read only memory (ROM) 4324 and random-access memory (RAM) 4325. A basic input/output system (BIOS) 4326, containing the basic routines that help transfer information between elements within the computer 20, such as during start-up, may be stored in ROM 4324.

The computer 4320 may also include a magnetic hard disk drive 4327 for reading from and writing to a magnetic hard disk 4339, a magnetic disk drive 4328 for reading from or writing to a removable magnetic disk 4329, and an optical disk drive 4330 for reading from or writing to removable optical disk 4331 such as a CD-ROM or other optical media. The magnetic hard disk drive 4327, magnetic disk drive 4328, and optical disk drive 30 are connected to the system bus 4323 by a hard disk drive interface 4332, a magnetic disk drive-interface 33, and an optical drive interface 4334, respectively. The drives and their associated computer-readable media provide nonvolatile storage of computer-executable instructions, data structures, program modules, and other data for the computer 4320. Although the exemplary environment described herein employs a magnetic hard disk 4339, a removable magnetic disk 4329, and a removable optical disk 4331, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 4339, magnetic disk 4329, optical disk 4331, ROM 4324, and/or RAM 4325, including an operating system 4335, one or more application programs 4336, other program modules 4337, and program data 4338. A user may enter commands and information into the computer 4320 through keyboard 4340, pointing device 4342, or other input devices (not shown), such as a microphone, joy stick, game pad, satellite dish, scanner, or the like. These and other input devices are often connected to the processing unit 4321 through a serial port interface 4346 coupled to system bus 4323. Alternatively, the input devices may be connected by other interfaces, such as a parallel port, a game port, or a universal serial bus (USB). A monitor 4347 or another display device is also connected to system bus 4323 via an interface, such as video adapter 4348. In addition to the monitor, personal computers typically include other peripheral output devices (not shown), such as speakers and printers.

The computer 4320 may operate in a networked environment using logical connections to one or more remote computers, such as remote computers 4349 a and 4349 b. Remote computers 4349 a and 4349 b may each be another personal computer, a server, a router, a network PC, a peer device or other common network node, and typically include many or all of the elements described above relative to the computer 4320, although only memory storage devices 4350 a and 4350 b and their associated application programs 36 a and 36 b have been illustrated in FIG. 1A. The logical connections depicted in FIG. 4 include a local area network (LAN) 4351 and a wide area network (WAN) 4352 that are presented here by way of example and not limitation. Such networking environments are commonplace in office-wide or enterprise-wide computer networks, intranets and the Internet.

When used in a LAN networking environment, the computer 4320 is connected to the local network 4351 through a network interface or adapter 4353. When used in a WAN networking environment, the computer 4320 may include a modem 4354, a wireless link, or other means for establishing communications over the wide area network 4352, such as the Internet. The modem 4354, which may be internal or external, is connected to the system bus 4323 via the serial port interface 4346. In a networked environment, program modules depicted relative to the computer 4320, or portions thereof, may be stored in the remote memory storage device. It will be appreciated that the network connections shown are exemplary and other means of establishing communications over wide area network 4352 may be used.

One or more aspects of the invention may be embodied in computer-executable instructions (i.e., software), such as a software object, routine or function (collectively referred to herein as a software) stored in system memory 4324 or non-volatile memory 4335 as application programs 4336, program modules 4337, and/or program data 4338. The software may alternatively be stored remotely, such as on remote computer 4349a and 4349b with remote application programs 4336b. Generally, program modules include routines, programs, objects, components, data structures, etc. that perform particular tasks or implement particular abstract data types when executed by a processor in a computer or other device. The computer executable instructions may be stored on a computer readable medium such as a hard disk 4327, optical disk 4330, solid state memory, RAM 4325, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

A programming interface (or more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The teen “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a run-time system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any (or all) of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the provided detailed description. Some illustrative implementations of a programming interface may also include factoring, redefinition, inline coding, divorce, rewriting, to name a few. There are, however, other ways to implement a programming interface, and, unless expressly excluded, these, too, are intended to be encompassed by the claims set forth at the end of this specification.

Embodiments within the scope of the present invention also include computer-readable media and computer-readable storage media for carrying or having computer-executable instructions or data structures stored thereon. Such computer-readable media can be any available media that can be accessed by a general purpose or special purpose computer. By way of example, and not limitation, computer-readable storage media may comprise RAM, ROM, EEPROM, CD-ROM or other optical disk storage, magnetic disk storage, or other magnetic storage devices, e.g., USB drives, SSD drives, etc., or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general-purpose computer, special purpose computer, or special purpose processing device to perform a certain function or group of functions.

While various user functionality is described above, these examples are merely illustrative of various aspects of the present invention and is not intended as an exhaustive or exclusive list of features and functionality of the invention. Other features and functionality, while not expressively described, may be provided and/or utilized to effect and/or execute the various displays, functionality, data storage, etc.

According to aspects of the present invention, embodiments of present invention may include one or more special purpose or general-purpose computers and/or computer processors including a variety of computer hardware. Embodiments may further include one or more computer-readable storage media having stored thereon firmware instructions that the computer and/or computer processor executes to operate the device as described below. In one or more embodiments, the computer and/or computer processor are located inside the apparatus, while in other embodiments, the computer and/or computer processor are located outside or external to the apparatus.

One of ordinary skill in the pertinent arts will recognize that, while various aspects of the present invention are illustrated in the FIGURES as separate elements, one or more of the elements may be combined, merged, omitted, or otherwise modified without departing from the scope of the present invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1: A computerized method for generating a personalized item via a mobile device, said method comprising:
determining, at the mobile device, a location of the mobile device;
receiving, at the mobile device, a first selection from a user via at least one user interface, said first selection comprising at least one of the determined location and an event from a list of available events;
receiving, at the mobile device, a second selection from the user indicating a desired template via said user interface;
receiving, at the mobile device, a third selection from the user via said user interface, said third selection comprising a photograph, said photograph being at least one of an existing photograph and a photograph captured during said third selection;
receiving, at the mobile device, personalization information from the user via said user interface;
receiving, at the mobile device, a fourth selection from the user via said user interface, said fourth selection comprising user-selected photograph modification attributes;
displaying, at the mobile device, a preview of the personalized item based on said first selection, said second selection, said personalization information, said third selection, and said fourth selection;
receiving, at the mobile device, a user confirmation to continue based on said displayed preview;
receiving, at the mobile device, a purchase selection from the user, said purchase decision comprising at least one of a digital-only purchase selection and a print/digital purchase selection; and
selectively executing, at the mobile device, a purchasing process based on said received purchase selection.

2: The computerized method of claim 1, wherein said purchasing process for said digital-only purchase selection comprises:
completing, at the mobile device, an in-application purchase process on the mobile device; and
displaying, at the mobile device, at least one indicator related to the personalized item.

3: The computerized method of claim 1, wherein said purchasing process for said print/digital purchase selection comprises:
receiving, at the mobile device, user information from the user, said user information being indicative of at least one of a user account and address information for the user;
receiving, at the mobile device, a selected payment option from the user, said selected payment option including at least one of an in-application purchase process native to the mobile device and an alternate payment process;
completing, at the mobile device, an in-application purchase process on the mobile device;
displaying, at the mobile device, at least one indicator related to the personalized item.

4: The computerized method of claim 3, wherein said indicator comprises at least one of an embedded image of the personalized item; a uniform resource location (URL) via which the user may retrieve the personalized item; and information regarding physical shipment of a print version of the personalized item.
